(19) United States
(12) Patent Application Publication
(10) Pub. No.: US 2002/0160709 A1
(43) Pub. Date: Oct. 31, 2002

(54) Wireless music system

(76) Inventor: Ing-Der Kuo, Cupertino, CA (US)

Correspondence Address: GLENN PATENT GROUP, 3475 EDISON WAY, SUITE L, MENLO PARK, CA, 94025, US

(21) Appl. No.: 09/879,022

(22) Filed: Jun. 11, 2001

Related U.S. Application Data
(63) Continuation-in-part of application No. 09/842,773, filed on Apr. 25, 2001.

(51) Int. Cl. H04M 1/00

(52) U.S. Cl. 455/3.06; 455/42; 455/568

(57) ABSTRACT

A wireless method and apparatus for transmitting signal, for example, from a source, to headphones or speakers, while allowing relatively unrestricted range of movement/placement for the headphones or speakers. An infrared transmitter diverges its signal by passing the signal through a concave lens. The signal is processed to bounce off of objects, such as, walls, ceilings and floors before reaching the receiver on the headphones/speakers. The receiver has a convex lens affixed to it, so as to converge the transmitted signal. The signal is polarized so that ambient light is filtered.

### CROSS-REFERENCE TO RELATED-APPLICATIONS

This application is a Continuation-in-Part to U.S. Ser. No. 09/842,773, filed Apr. 25, 2001 (Attorney Docket No. GALL0010).

### BACKGROUND OF THE INVENTION

1. Technical Field

The invention relates generally to wireless headphones and speakers and, more particularly, is directed to wireless headphones and speakers in which a satisfactory receiving condition is always maintained regardless of the condition and position.

2. Description of the Prior Art

A wireless headphone system has recently been developed, in which a signal is transmitted through infrared rays from a transmitter and received at a remote position from the transmitter, so a listener can enjoy music. Japanese Laid-Open Patent Gazette No. 55-82596 describes a wireless headphone using infrared rays. This headphone is a wireless-type headphone, so that the usable range the user uses the headphone is not limited by a headphone cord. Further, using infrared rays prevents the wireless headphone from interfering with other radio waves. An infrared signal transmitted from a transmitter is received by a light-receiving element provided on a top portion, of a headband portion, of the wireless headphone. A signal outputted from the light-receiving element is supplied through an amplifier. A demodulating circuit and a reproducing circuit are powered by a power supply source such as a battery incorporated within the headphone. The receive signal is demodulated and reproduced in the headphone unit portion.

Abe, Wireless Headphones, U.S. Pat. No. 5,095,382, Mar. 10, 1992 teaches the use of multiple receivers on the headphones. This is done to increase the number of locations where the transmitted signal is received. This also reduces the likelihood that the signal is not received.

The problem with these solutions is that they focus only on improving the receiver, not the transmitter. Irrespective of how many receivers are put on a pair of headphones, it still does not receive a signal if there is no signal at that location. Multiple transmitters can be used to increase coverage, but this results in greatly increased costs and occupies more space. What is needed is a solution that improves the coverage of an infrared transmitter without greatly increasing the cost or space used.

Similarly, wireless speakers receive a transmitted infrared signal from a transmitter. The problem with current solutions is they take time to setup because most transmitters have limited coverage. Much time must be taken to properly place the speakers, and to ensure that they can receive the signal. What is need is a method to improve infrared signal coverage.

### SUMMARY OF THE INVENTION

A method and apparatus is disclosed which provides for a wireless method to transmit a signal from a stereo to wireless headphones or speakers. Typically the signal is analog, but the signal may also contain data. An infrared beam transmitter diverges its signal by passing through a concave lens. The divergent beam has a wider range than a non-divergent signal. The beam is designed to bounce off of walls, ceilings and floors before reaching the receiver on the headphones/speakers. This way, a person wearing headphones can move about the coverage area without losing the signal, or speakers may be placed anywhere in a room, without worry that the signal is not received.

The receiver may also have a convex lens affixed to it so as to converge the transmitted signal. The convex lens focuses the signal so that transmitter can better interpret it. The signal may also be polarized so that the receiver filters out ambient light. Ambient light causes signal noise. Thus, filtering out the noise increases signal to noise ratio.

### BRIEF DESCRIPTION OF THE DRAWINGS

FIG. 1 is a diagram illustrating a pair of headphones and a transmitter according to the invention;

FIG. 2 is a diagram illustrating a transmitter with a concave lens according to the invention;

FIG. 3 is a diagram illustrating a receiver with a concave and convex lens according to the invention;

FIG. 4 is a diagram illustrating a transmitter with a polarizer according to the invention;

FIG. 5 is a diagram illustrating a receiver with a polarizer according to the invention;

FIG. 6 is diagram illustrating linearly polarized light according to the invention;

FIGS. 7A and 7B are diagrams illustrating linearly polarized light over an angular range according to the invention;

FIG. 8 is a diagram illustrating the light spectrum,

FIGS. 9A, 9B and 9C are diagrams illustrating a counter-weighted receiver according to the invention;

FIGS. 10A, 10B and 10C are diagrams illustrating a reflective signal according to the invention;

FIG. 11 is a diagram illustrating a parabolic deflector according to the present invention;

FIG. 12 is a diagram illustrating an infrared receiver combined with selfamplified, wireless speakers;

FIG. 13 is a diagram illustrating a sound encoder that lies in line between the input television signal producer and a television; and

FIG. 14 is a diagram illustrating rear surround speakers mounted onto a stand with an amplifier.

### DESCRIPTION OF THE PREFERRED EMBODIMENT

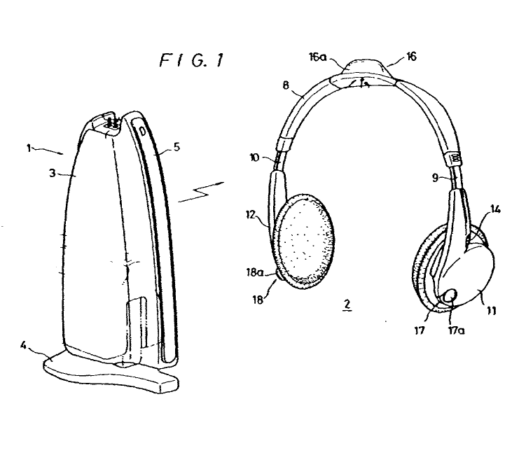

FIG. 1 illustrates a wireless headphone system according to an embodiment of the present invention, which comprises a transmitter 1 and a wireless headphone 2. A transmitted infra-red light signal transmitted from the transmitter 1 is received by the wireless headphone 2 which in turn, reproduces an audio signal from the received light signal and supplies the same to unit portions 11 and 12 so as to be heard by the listener. The wireless headphone is powered by a battery.

As shown in FIG. 1, the transmitter 1 is generally comprised of a transmitter body 3 and a leg or base 4 that supports the transmitter body 3. An audio signal is supplied to the transmitter from an audio apparatus through an input cable (not shown), whereupon the audio signal is converted to a modulated infrared transmission light signal, which is transmitted from a light-transmitting portion 5 of the transmitter 1. The transmitter body 3 is adapted to be rotatable, relative to the base 4, so as to vary the direction in which the transmission light signal is transmitted.

As shown in FIG. 1, the wireless headphone 2 is generally comprised of a headband portion 8 and a pair of headphone unit portions 11 and 12, which are supported by the two end portions of the head band portion 8 through hanger portions 9 and 10, respectively. The headphone unit portions 11 and 12 each incorporate speakers therein (not shown). Dial 14 is used to adjust the sound volume.

Wireless headphone 2 is provided with light receiving portions 16, 17 and 18 at three portions of headphone 2, that is, the central top portion or top portion of the head band portion 8 and the front side portions of the left and right headphone unit portions 11 and 12. The light receiving portions 16, 17 and 18 are covered with filter caps 16a, 17a and 18a, respectively which, in a preferred embodiment, are pervious only to infrared signals.

The light-receiving portion 16 is provided on the top portion of the headband portion 8. The received transmitted light signal is demodulated to provide an audio signal, which is reproduced by the headphone unit portions 11 and 12 as an audio sound.

The wireless headphone system receives a transmitted light signal, even when the listener wearing the headphone turns his or her head in any direction. That is, one of the three light receiving portions 16, 17 and 18 receives the transmitted light signal. The wireless headphones include electronic circuits that may include an amplifying circuit. A circuit board is located within a filter cap for supporting a light-receiving element.

Three light receiving portions 16, 17 and 18 are provided on the top portion of the headband portion 8 and on the respective headphone unit portions 11 and 12, as previously described. As a result, even when one of the light receiving portions is hidden by the listener's hair, other light receiving portions receive the transmitted light signal from the transmitter 1.

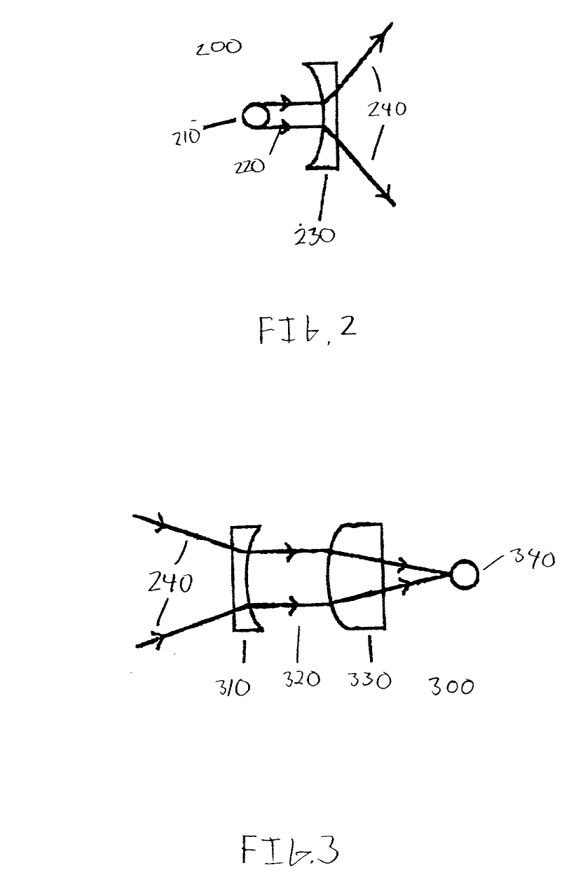

FIG. 2 illustrates a preferred embodiment of the transmitter 200. In this embodiment, a light-emitting element 210 emits an infrared signal 220. The signal is diverged through a plano-concave lens 230. The effect of a divergent signal 240 is a signal that has a wider swath than a non-divergent signal 220, and thus there is more area covered by the signal. Typically the lens 230 is constructed of glass, plastic or other material with similar refractive qualities.

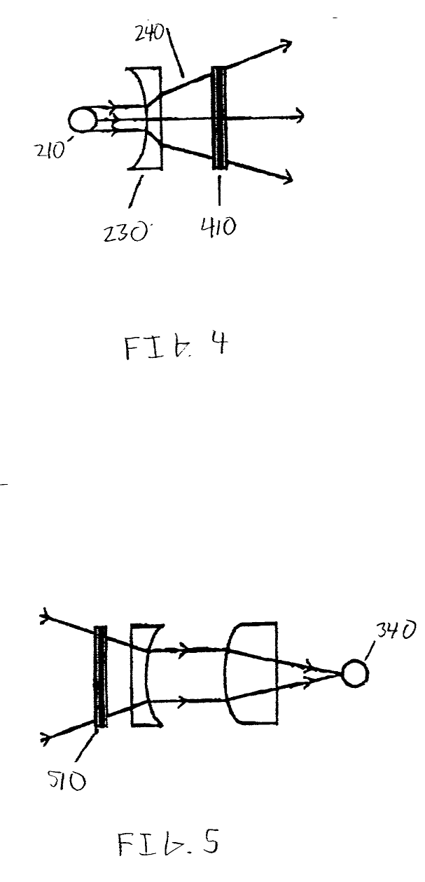

FIG. 3 illustrates a receiver 300 according to a preferred embodiment. A plano-concave lens 310 is placed so as to first receive incoming infrared signals 240. The piano-concave lens 310 is placed so as to converge the incoming signal 240 and produce a signal that has a substantially straight pattern 320. The piano-concave lens 310 can receive signals at high incident angles. After the signal passes through the plano-concave lens, it passes through a piano-convex lens 330. The piano-convex lens converges the signal onto the receiver potion 340.

FIGS. 4 and 5 illustrate another embodiment where the signal is transmitted through a linear polarizer 410 at the transmitter 210, and received through a similarly orientated linear polarizer 510 at the receiver. Light can be represented as a transverse electromagnetic wave made up of mutually perpendicular, fluctuating electric and magnetic fields. The light has an electric field and a magnetic field each lying in perpendicular planes, propagating in the same direction.

The sinusoidally varying electric field can be thought of as a length of rope held by two children at opposite ends. The children begin to displace the ends in such a way that the rope moves in a plane, either up and down, left and right, or at any angle in between.

Ordinary white light is made up of waves that fluctuate at all possible angles. Light is considered to be linearly polarized when it contains waves that only fluctuate in one specific plane. It is as it the rope is strung through a picket fence—the wave can move up and down, but motion is blocked in any other direction. A polarizer is a material that allows only light with a specific angle of vibration to pass through. The direction of fluctuation passed by the polarizer is called the easy axis.

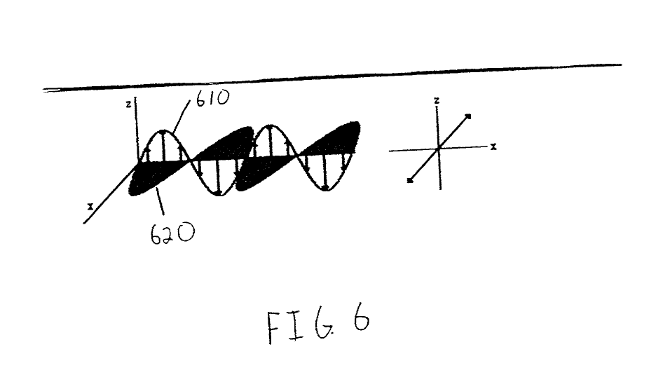

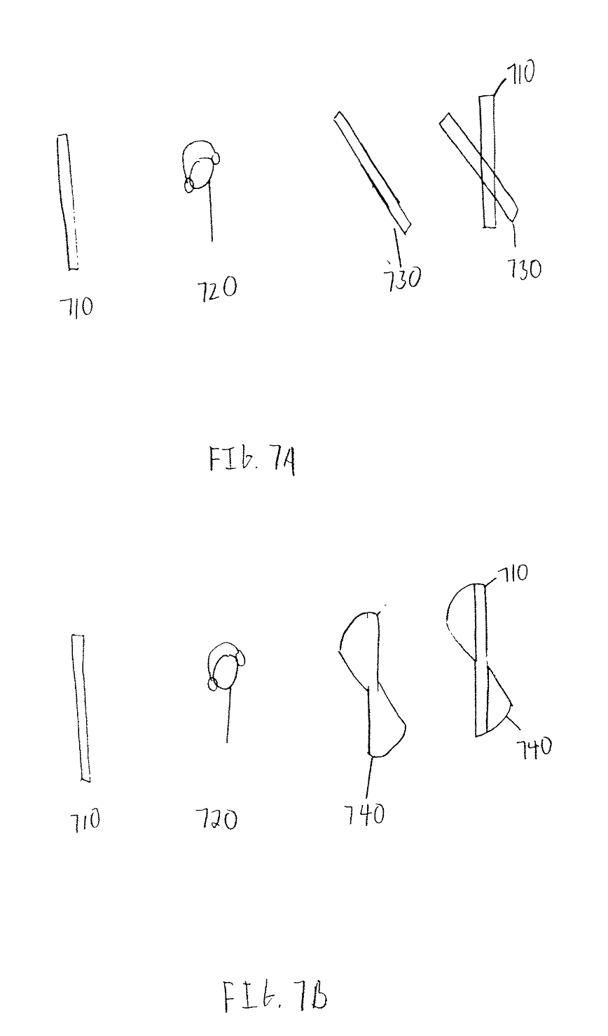

Linear polarization is merely a special case of circularly polarized light. In FIG. 6, consider two light waves, one polarized in the YZ 620 plane and the other in the XY plane 610. If the waves reach their maximum and minimum points at the same time, their vector sum leads to one wave, linearly polarized at 45 degrees. Similarly, if the two waves are 180 degrees out of phase, the resultant is linearly polarized at 45 degrees in the opposite sense (not shown).

The effect of using polarized light is that the linear polarizer at the receiver, substantially screens out light that is not in the same plane as the linearly polarized signal from the transmitter. This increases the signal to noise ratio, the non-signal light considered to be noise. Additionally, the polarizer allows the use of a less sensitive receiver, resulting in a cost savings.

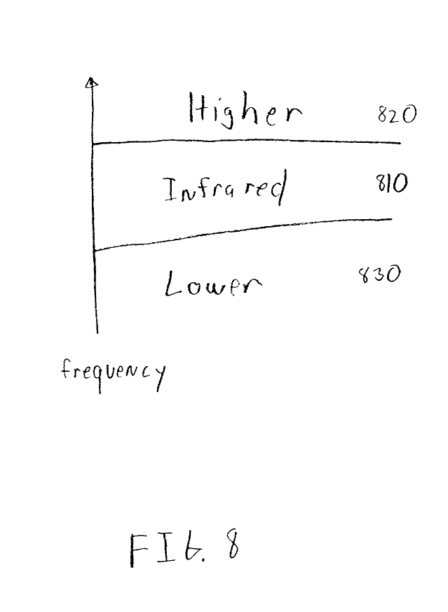

In another embodiment, the linear polarizers transmit and receive the signal over an angular range, for example thirty degrees. The effect of transmitting and receiving the signal over an angular range is to decrease the likelihood that the respective polarizers are out of alignment, which causes a lack of signal reception at the receiver. FIG. 7A, illustrates a signal 710 created from a linear polarizer at the transmitter, where the signal lies on a linear vertical plane, a user who has tilted his head to the left 720, and the corresponding orientation of the linear polarizer 730 at the receiver. The angled orientation of the receiver polarizer 730, causes the polarizer at the receiver, and the polarizer at the transmitter to be out of alignment. This results in much signal being lost and not received by the receiver.

FIG. 7B, illustrates where a polarizer is designed to receive a signal at a range of angles 740. The transmitter emits a linearly polarized signal 710 that lies in the vertical plane. As the user angles his head 720, the polarizer 740 at the receiver, stays in alignment with the polarizer at the transmitter, because no part of the signal 710 lies outside the area covered by the polarizer 740 at the receiver. Thus, because the receiver is able to fully receive the incoming signal, there is no signal loss.

In another preferred embodiment, a filter is used to filter out frequencies of light that are not in the infrared range. A film coating is applied to the receiver that allows infrared light to pass through, but absorbs or reflects light of other frequencies.

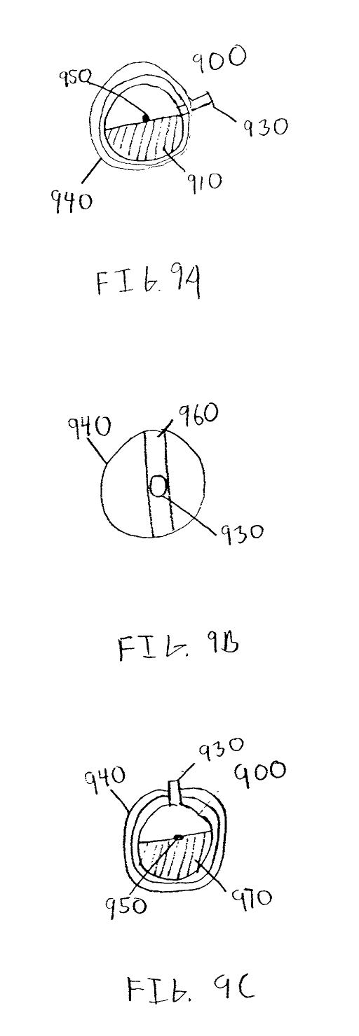

In another embodiment, a computing element, at the receiver, samples the whole signal and filters out frequencies that do lie in the infrared spectrum. As can be seen if FIG. 8, the infrared spectrum occupies a certain range of frequencies. Those frequencies that are higher 820 and lower 830 are filtered out. The result is an infrared signal that has a higher signal to noise ratio than an unfiltered signal.

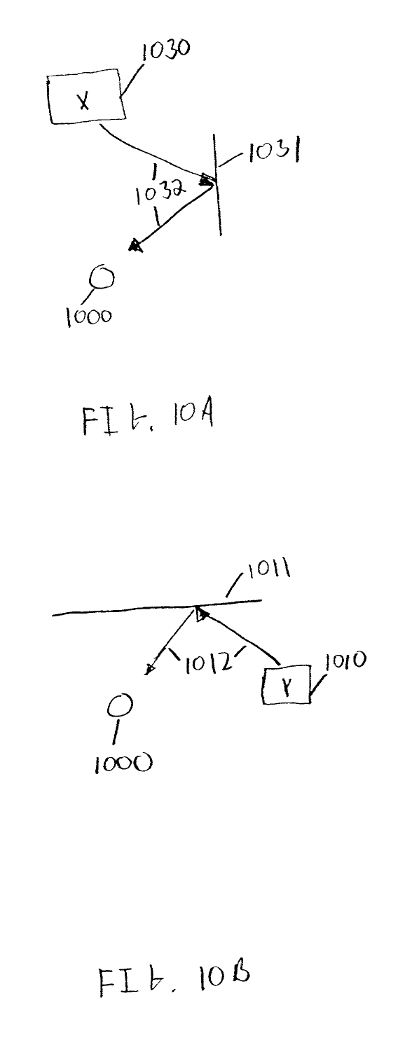

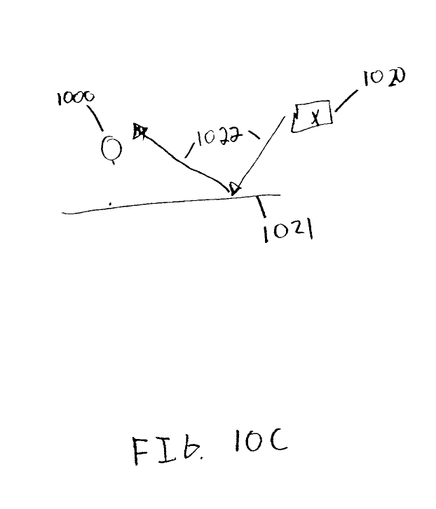

FIGS. 9A, 9B and 9C illustrate another embodiment of the invention where a counterweight 910 is attached to the receiver 900, such that the receiving portion 930 always lies substantially orientated in the same way. FIG. 9A illustrates a side view of the receiver 900, where the receiver 900 consists of a receiving portion 930, protruding from a contoured container 940. The receiver portion 930 is rotatably contained in the contoured container 940, and is attached to the container at a central point 950.

FIG. 9B illustrates a frontal view of the receiver, where the receiver portion 930 of the receiver lies in a slot 960 in the container 940 so that the receiver portion 930 can freely rotate without the container interfering with the rotation of the receiver portion. The counterweight 910 is adapted with the receiver 900, so that as the orientation of the receiver 900 changes, the receiver portion 930 rotates relative to the container 940 such that the receiving portion 930 remains substantially orientated the same.

The counterweight does this by effectively moving the center of gravity of the receiver away from the volumetric center of gravity. As the receiver is shifted, the receiver portion rotates around the centrally hinged position 950, such that the receiver 900 returns to its original position, to maintain static and dynamic equilibrium. FIG. 9C illustrates another embodiment where the counterweight 970 is designed to keep the receiving portion 930 directed in an upward direction.

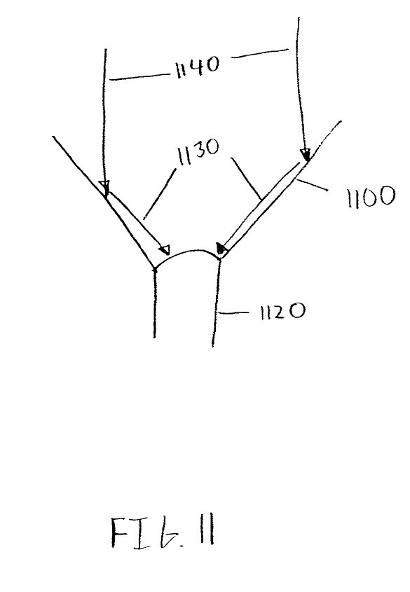

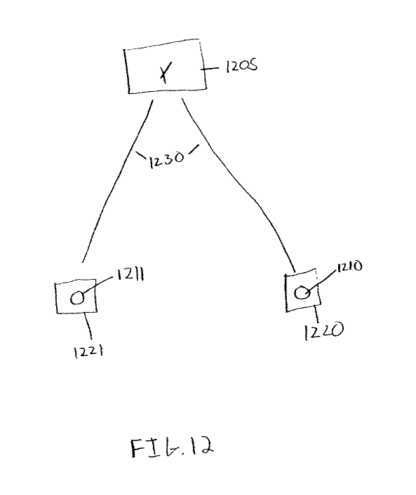

FIGS. 10A, 10B, and 10C illustrate another preferred embodiment of the invention where an array of transmitters are used. At least one transmitter is aimed such a way that the infrared signal is incident upon a receiver along a direct path, while the other transmitters 1010, 1020, 1030 are aimed to have their signal 1012, 1022, 1032 to be received by a receiver 1000 after reflecting off of an object, such as, a ceiling 1011, floor 1021 or wall 1031. It is also contemplated that the signal may reflect off of objects such as furniture, statues, wall hanging, and even family pets.

FIG. 11 illustrates another preferred embodiment where a parabolic deflector 1100 is combined with a receiver 1120, to increase the amount of signal received. The conical deflector is attached to a frontal portion of a receiver 1120. The interior of the deflector has high reflective qualities, causing an incident infrared signal 1140 to reflect off of its surface. The conical shape of the deflector causes a reflected signal 1130 to be incident upon the receiver 1120. It is contemplated that the deflector is adjustable to maximize the signal reflection.

In another embodiment of the invention, the infrared transmitter and receiver are used to transmit data across a distance. For example, a transmitter/receiver combination can be used for connecting with cable Internet. A typical Internet cable connection has a wire lead passing from the exterior of the home, through a hole in the wall, to an external network card that is connected to the computer. Using the transmitter/receiver combination, the cable passes through the hole in the wall, and in close proximity to the wall, plugs into the transmitter, which transmits a data signal. The receiver is integrated with the external modem, and receives the Internet signal from the transmitter, and the signal is transmitted from the network card to the computer.

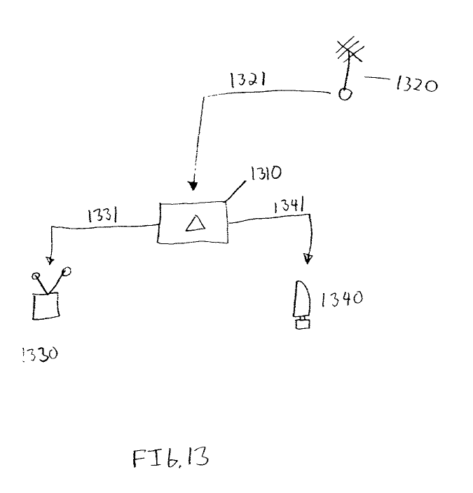

FIG. 12 illustrates another preferred embodiment where, an infrared receiver 1210, 1211 is combined with self-amplified, wireless speakers 1220, 1221. The speakers 1220, 1221 receive an input signal 1230 from an infrared transmitter 1205. The speakers can be used to produce stereo or surround sound. The speakers 1220, 1221 are placed in locations within the listening environment such that they produce an enjoyable listening experience.

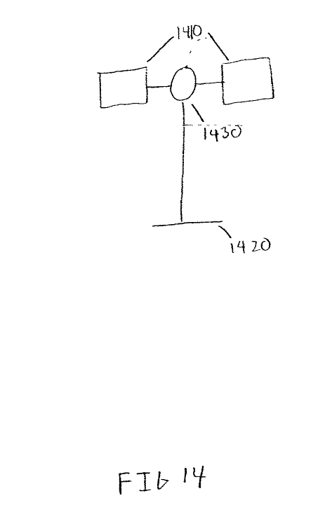

When used as surround sound speakers, the television's speakers are used to produce front and/or center channel sound. FIG. 13 illustrates a sound encoder 1310 that lies in line between the input television signal producer 1320, and the television 1330. The encoder 1310 processes the input stereo signal 1321 and directs front and center channel signals 1331 to the television 1330, and sends a surround sound signal 1341 to the transmitter 1340, which is then sent to the wireless speakers. Surround sound is produced from a stereo input signal by delaying the signal, so as to produce a spatial effect. Also, the surround sound volume level is typically lower than the front and center channels. It is also contemplated that a front center speaker is incorporated with the encoder such that the center speaker reproduces center channel signals from the encoder.

In another embodiment, a decoder processes a multi-channel surround encoded signal. The decoder directs front and center channel signals to the television, and surround sound signals to the transmitter.

In another embodiment of the invention, rear surround speakers 1410 are mounted onto a stand 1420 as shown in FIG. 14. An amplifier 1430 is used to amplify a rear surround sound signal received by an infrared receiver and to reproduce them through the rear surround speakers.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for sending a wireless audio signal from a transmitter to a receiver, allowing relatively unrestricted range of movement and placement of the receiver, comprising:
a signal generator;
at least one transmitting element operatively connected to said signal generator for transmitting infrared signals in a direction to reflect said signal off of an object;
a receiver, said receiver, receiving said infrared signal; and
a listening means.

2. The apparatus of claim 1, wherein said signal generator is an audio device.

3. The apparatus of claim 2, wherein said audio device comprises any of:
a CD player, tuner, tape playing device and phonograph.

4. The apparatus of claim 1, wherein said object comprises any of:
walls, ceilings, floors, furniture, wall hangings, fixtures, and living organisms.

5. The apparatus of claim 1, wherein said transmitted signal is divergent.

6. The apparatus of claim 1, further comprising:
a signal diverging means.

7. The apparatus of claim 6, wherein said signal diverging means is a plano-concave lens, said lens affixed to said transmitter to produce said divergent signal.

8. The apparatus of claim 1, wherein said listening means comprises any of:
headphones and speakers.

9. The apparatus of claim 1, further comprising:
a signal converging means.

10. The apparatus of claim 9, wherein said converging means is affixed to said receiver producing said convergent signal.

11. The apparatus of claim 11, wherein said signal converging means comprises any of:
a plano-convex lens and a plano-concave lens.

12. The apparatus of claim 1, further comprising:
a first linear polarizer, said first linear polarizer affixed to said transmitter.

13. The apparatus of claim 12, wherein said linear polarizer produces a signal which lies substantially in one plane.

14. The apparatus of claim 12, wherein said first linear polarizer produces a signal that lies in planes over an angular range.

15. The apparatus of claim 12, further comprising:
a second linear polarizer, said second linear polarizer in alignment with said first linear polarizer and connected to a receiver.

16. The apparatus of claim 15, wherein said second polarizer receives said signal over an angular range.

17. The apparatus of claim 1, further comprising:
a filtering means, said filtering means in combination with said receiver, said filtering means capable of filtering out light that does not lie in the infrared spectrum.

18. The apparatus of claim 17, wherein said filtering means comprises any of:
a coating and a computer.

19. The apparatus of claim 18, wherein said computer receives said signal and electronically subtracts signal wavelengths not in the infrared spectrum.

20. The apparatus of claim 1, further comprising:
a parabolic deflector, said deflector designed to reflect an incoming signal toward a receiving portion of said receiver.

21. The apparatus of claim 1, further comprising:
a counter-weight, said counter-weight integrated with said receiver so as to cause a receiving portion of said receiver to stay level.

22. The apparatus of claim 1, wherein said signal contains data.

23. The apparatus of claim 22, further comprising:
a network card, said network card integrated with said receiver, said network card connected to computer and transmitting said data signal to said computer.

24. An apparatus for providing a wireless means for transmitting a signal from a source to headphones or speakers, comprising:
an infrared transmitter which transmits an infrared signal;
a processing means which allows said signal to reflect off objects;
a concave lens which diverges said infrared signal;
a converging means for converging said reflected signal;
a receiver which receives said reflected signal; and
a listening means for listening to said signal.

25. A method for sending a wireless audio signal from a transmitter to a receiver, allowing relatively unrestricted range of movement and placement of the receiver, comprising the steps of:
generating a signal with a signal generating means;
transmitting a signal in a direction to reflect off of an object with at least one transmitting element operatively connected to said signal generating means;
receiving said infrared signal with a receiver; and
listening to said signal with a listening means.

26. The method of claim 25, wherein said signal generator is an audio device.

27. The method of claim 26, wherein said audio device comprises any of:
a CD player, tuner, tape playing device and phonograph.

28. The method of claim 25, wherein said object comprises any of:
walls, ceilings, floors, furniture, wall hangings, fixtures, and living organisms.

29. The method of claim 25, wherein said transmitted signal is divergent.

30. The method of claim 25, further comprising the step of:
diverging said signal with a signal diverging means.

31. The method of claim 30, wherein said signal diverging means is a plano-concave lens, said lens affixed to said transmitter to produce said divergent signal.

32. The method of claim 25, wherein said listening means comprises any of:
headphones and speakers.

33. The method of claim 25, further comprising the step of:
converging a signal with a signal converging means.

34. The method of claim 33, wherein said converging means is affixed to said receiver producing said convergent signal.

35. The method of claim 33, wherein said signal converging means comprises any of:
a plano-convex lens and a plano-concave lens.

36. The method of claim 25, further comprising the step of:
polarizing said signal with a first linear polarizer, said first linear polarizer affixed to said transmitter.

37. The method of claim 36, wherein said linear polarizer produces a signal that lies substantially in one plane.

38. The method of claim 36, wherein said first linear polarizer produces a signal that lies in planes over an angular range.

39. The method of claim 36, further comprising the step of:
filtering said signal with a second linear polarizer, said second linear polarizer in alignment with said first linear polarizer and connected to a receiver.

40. The method of claim 39, wherein said second polarizer receives said signal over an angular range.

41. The method of claim 25, further comprising the step of:
filtering out light that does not lie in the infrared spectrum with a filtering means, said filtering means in combination with said receiver.

42. The method of claim 41, wherein said filtering means comprises any of:
a coating and a computer.

43. The method of claim 42, wherein said computer receives said signal and electronically subtracts signal wavelengths not in the infrared spectrum.

44. The method of claim 25, further comprising the step of:
reflecting an incoming signal toward a receiving portion of said receiver with a parabolic deflector.

45. The method of claim 25, further comprising the step of:
maintaining a constant receiver level with a counter-weight, said counter-weight integrated with said receiver.

46. The method of claim 25, wherein said signal contains data.

47. The method of claim 46, further comprising the step of:
transmitting said data signal with a network card, said network card integrated with said receiver, said network card connected to computer and transmitting said signal to said computer.

48. A method for providing a wireless means for transmitting a signal from a source to headphones or speakers, comprising the steps of:
transmitting infrared signal with an infrared transmitter;
processing said signal to reflect off objects;
diverging said infrared signal with a concave lens;
converging said reflected signal;
receiving said reflected signal with a receiver; and
listening to said signal.

49. A surround sound system comprising:
a surround sound derivation means, said derivation means producing rear surround sound signals from input left and right channel information; and
a front channel director, said director receiving said input channel information and providing left and right front surround sound signals to a television.

50. The system of claim 49, further comprising:
a transmitting means for transmitting said rear signals to wireless speakers.

51. The system of claim 50, wherein said transmitting means comprises:
an infrared transmitter which transmits an infrared signal capable of being substantially received after being reflected; and
a diverging means that diverges said infrared signal.

52. The system of claim 51, further comprising a polarizer that polarizes said infrared signal.

53. The system of claim 51, wherein said diverging means is a concave lens.

54. The system of claim 51, wherein said wireless speakers comprise:
a converging means for converging a reflected signal; and
a receiver which receives said reflected signal.

55. The system of claim 54, wherein said converging means comprises any of:
a concave lens and convex lens.

56. The system of claim 49, further comprising:
left and right speakers, said speakers coupled to said television.

57. The system of claim 56, wherein said left front signal is audibly reproduced by said left speaker and said right front signal is audibly reproduced on said right speaker.

58. The system of claim 49, wherein said surround sound is produced by delaying said rear signals.

59. The system of claim 49, further comprising:
rear left and right speakers coupled to a stand and an amplifier.

60. The system of claim 49, wherein said front channel director receives center channel information, and directs said center channel information to a center speaker.

61. A surround sound system comprising:
a surround sound processor, said processor producing rear surround sound signals from input left and right channel information, said input channel information from a computer sound card;
rear left and right speakers coupled to a stand, said rear speakers audibly reproducing said rear surround sound signals; and
a front channel director, said director receiving said input channel information and providing left and right front surround sound signals.

62. A method for producing a surround sound system comprising the steps of:
producing rear surround sound signals from input left and right channel information; and
receiving said input channel information and providing left and right front surround sound signals to a television.

63. The method of claim 62, further comprising the step of:
transmitting said rear signals to wireless speakers.

64. The method of claim 63, wherein said transmitting step comprises the steps of:
transmitting an infrared signal with a transmitter;
reflecting said signals; and
diverging said infrared signal.

65. The method of claim 64, further comprising the step of:
polarizing said infrared signal.

66. The method of claim 64, wherein a concave lens produces said diverging.

67. The method of claim 63, wherein said wireless speakers comprise:
a converging means for converging said reflected signal; and
a receiver which receives said reflected signal.

68. The method of claim 67, wherein said converging means comprises any of:
a concave lens and convex lens.

69. The method of claim 62, further comprising the step of:
coupling left and right speakers to said television.

70. The method of claim 69, wherein said left front signal is audibly reproduced by a left front speaker and said right front signal is audibly reproduced on a right front speaker.

71. The method of claim 62, wherein said surround sound is produced by delaying said rear signals.

72. The method of claim 62, further comprising the step of:
rear left and right speakers coupled to a stand and an amplifier.

73. The method of claim 62, further comprising the step of:
directing center channel information to a center speaker.

74. A method for producing a surround sound system comprising the steps of:
producing rear surround sound signals from input left and right channel information, said input channel information from a computer sound card;
audibly reproducing said rear surround sound signals with rear left and right speakers, said rear speakers coupled to a stand;
receiving said input channel information with a front channel director; and
providing left and right front surround sound signals with said front channel director.
